(19) United States
(12) Patent Application Publication
(10) Pub. No.: US 2005/0173415 A1
(43) Pub. Date: Aug. 11, 2005

(54) Heating apparatus

(75) Inventors: Naoyuki Yamamoto, Toride-shi (JP); Tokihiko Ogura, Kashiwa-shi (JP); Yasuo Nami, Toride-shi (JP); Takahiro Nakase, Toride-shi (JP); Hitoshi Suzuki, Matsudo-shi (JP); Toshiharu Kondo, Moriya-shi (JP); Yasuhiro Yoshimura, Ryugasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/019,129

(22) Filed: Dec. 22, 2004

(30) Foreign Application Priority Data
Dec. 26, 2003 (JP) 434280/2003(PAT.

(51) Int. Cl. H05B 6/14

(52) U.S. Cl. 219/619

(57) ABSTRACT

In a widthwise direction of a heating roller perpendicular to a sheet conveyance direction, an amount of magnetic flux acting on the heating roller in the neighborhood of an end portion of the heating roller is larger than that at a center portion of the eating roller, so that it is possible to prevent a lowering in temperature at the heating roller end portion. Further, in a temperature range in which a temperature of the heating roller is higher than a fixation temperature and is lower than a heat-resistant temperature of a heating apparatus, the heating roller has a temperature area in which a resistance thereof is lowered, so that it is possible to reduce temperature rise in a differential area between a large-sized sheet passing area and a small-sized sheet passing area when a sheet having a size smaller than a maximum size (non-sheet passing portion temperature rise).

### FIELD OF THE INVENTION AND RELATED ART

The present invention relates to a heating apparatus for heating an image on a material to be heated. For example, the present invention relates to an electromagnetic induction heating type heating apparatus suitable for a fixing apparatus for heat-fixing an unfixed toner image, which is heat-fusible and is formed and borne on a recording material directly or through transfer, in an electrophotographic type or electrostatic recording type image forming apparatus, such as a copying machine, a printer, or a facsimile machine.

A image forming apparatus of an electrophotographic type or the like is provided with a heating apparatus (fixing apparatus) for heat-fixing on a recording sheet an unfixed toner image which is formed and carried through transfer or directly on a recording sheet such as recording paper or a transfer material as a material to be heated.

The heating apparatus generally includes a heating roller or an endless heating belt which causes toner on the recording sheet to melt under heating and a pressure means for being pressed against the heating roller or belt via the recording sheet disposed therebetween.

The heating roller is directly or indirectly heated internally or externally by a heat generating element such as a halogen heater or a resistance heat generating element. However, in recent years, prim importance is placed on realization of energy saving of the image forming apparatus and improvement is usability (in terms of quick print or reduction in warm-up time) in combination, so that there has been proposed a heating apparatus using an electromagnetic induction heating scheme having a high heat generation efficiency (hereinafter, referred to as an “induction heating apparatus”) as disclosed in, e.g., Japanese Laid-Open Patent Application (JP-A) No. Sho 59-33787.

The induction heating apparatus generates an induced current (eddy current) in a hollow heating roller comprising a metal conductor (electroconductive member, magnetic material or induction heat generating element) and causes the heating roller itself to generate Joule heat by a skin resistance of the heating roller itself. According to this induction heating apparatus, a heat generation efficiency is significantly improved, thus permitting reduction in warm-up time.

However, in such an induction heating apparatus, heat is generated by an electric power proportion to a skin resistance which is determined by a frequency of applied high-frequency current, a permeability of the heating roller, and a specific resistance. Accordingly, a heat generating rate is not changed even when the heating roller has a large thickness. For this reason, in the case where the heating roller has a large thickness, a resultant heat generation efficiency is rather lowered, so that it is difficult to attain the effect of reducing the warm-up time. On the other hand, when the thickness of the heating roller is excessively small, magnetic flux penetrates through the heating roller, whereby the heat generation efficiency is lowered and a metallic member located in the neighborhood of the heating roller is heated. Accordingly, it is desirable that the thickness of the heating roller is approximately 50-2000 μm.

However, unless the heating roller has a sufficient thickness, heat transfer toward a roller axis direction is not readily achieved, so that in the case where, e.g., a recording sheet having a size smaller than a length of the heating roller is subjected to fixation, a temperature of the heating roller at a non-sheet passing portion (out-of-pass portion) which is a differential area between a large-sized sheet passing area and a small-sized sheet passing area becomes (excessively) higher than a sheet passing portion (hereinafter, this phenomenon is referred to as “(excessive) non-sheet passing portion temperature rise”).

In this case, for example, when an ordinary-sized sheet is subjected to fixation immediately after the fixation for a small-sized sheet, hot offset is liable to occur due to the non-sheet passing portion temperature rise.

As described in, e.g., JP-A No. 2000-39797, an induction heating apparatus using a magnetism-adjusted alloy, which has a Curie temperature adjusted to a predetermined fixation temperature, as a material for a heating roller has been proposed. The magnetic material generally loses spontaneous magnetisation when it is heated up to a temperature which exceeds a Curie temperature intrinsic to the material used, so that magnetic flux generated in the magnetic material is decreased. As a result, an eddy current induced in the magnetic material is decreased, whereby a heat generating rate of the magnetic material is also decreased. Accordingly, the heating roller is not heated up to a temperature exceeding a predetermined temperature by using the magnetism-adjusted alloy which has the Curie temperature adjusted to the predetermined fixation temperature. As a result, it is possible to improve the above described non-sheet passing portion temperature rise phenomenon.

However, in order to attain the effect of reducing the warm-up time in such an induction heating apparatus using the magnetism-adjusted alloy having the Curie temperature adjusted to the predetermined fixation temperature as the material for the heating roller, when the thickness of the heating roller is made thin, less heat transfer is caused in a longitudinal direction of the heating roller due to the insufficient thickness. Further, at both end portions of the heating roller in its longitudinal direction, a heat dissipating rate is larger than that at a center portion thereof. FOr this reason, a temperature of the heating roller at the both end portions is lower than a temperature at the center portion in the case of effecting fixation with an ordinary-sized sheet or in a standby state in which the fixation operation is not performed (hereinafter, referred to as a “end portion temperature lowering”).

As a result, there arises such a problem that fixation failure is caused to occur in the case of continuous fixation with a recording sheet or fixation with a thick recording sheet. Further, in the case where the fixation temperature is set to be high so as not to cause the fixation failure, energy consumption is increased and a resultant gloss is different between at the center portion and at the both end portions.

Further, in the induction heating apparatus using, as the heating roller material, the magnetism-adjusted alloy having the Curie temperature which has been adjusted to the predetermined temperature, when the temperature of the heating roller is kept at a fixation temperature, which is lower than the Curie temperature, by a temperature control means, the above described end portion temperature lowering becomes further noticeable.

### SUMMARY OF THE INVENTION

An object of the present invention is to provide a heating apparatus capable of alleviating a temperature rise (non-sheet passing portion temperature rise) in a differential area between a large-sized sheet passing area and a small-sized sheet passing area in the case where a material to be heated having a size smaller than a maximum (conveyable) size is conveyed, while preventing a lowering in temperature at end portions of heat generation member where a Curie temperature of the heat generation member is not less than a fixation temperature and is less than a heat-resistant temperature of the heating apparatus.

According to an aspect of the present invention, there is provided a heating apparatus, comprising:

a heat generation member for generating heat by magnetic flux generated by magnetic flux generation means; the heat generation member heating an image, on a material to be heated, by the heat generated by the heat generation member,

wherein the heat generation member has a Curie temperature which is not less than an image heating temperature and is less than a heat-resistant temperature of the heating apparatus, and an amount of magnetic flux generated by the magnetic flux generation means at an end portion of the heat generation member is larger than that at a center portion of the heat generation member in a widthwise direction of the heat generation member perpendicular to a conveyance direction of the material to be heated.

According to another aspect of the present invention, there is provided a heating apparatus, comprising:

a heat generation member for generating heat by magnetic flux generated by magnetic flux generation means, the heat generation member heating an image on a material, to be heated, by the heat generated by the heat generation member,

wherein the heat generation member has at least a temperature area in which a resistance thereof is decreased with temperature rise thereof within a temperature range in which a temperature of the heat generation member is lower than a heat-resistant temperature of the heating apparatus, and an amount of magnetic flux generated by the magnetic flux generation means at an end portion of the heat generation member is larger than that at a center portion of the heat generation member in a widthwise direction of the heat generation member perpendicular to a conveyance direction of the material to be heated.

This and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic structural view of an image forming apparatus in Embodiment 1 according to the present invention.

FIG. 2 is an enlarged cross-sectional view of a principal part of a fixing apparatus (a heating apparatus of an electromagnetic induction heating type) in Embodiment 1.

FIG. 3 is a schematic front view of the principal part.

FIG. 4 is a longitudinal-sectional front view of the principal part.

FIG. 5 is a view for illustrating a heating principle in the present invention.

FIG. 6 is a view showing arrangement of an exciting core material of the fixing apparatus in Embodiment 1.

FIG. 7 is a graph showing a temperature distribution in a longitudinal (lengthwise) direction of the heating roller of the fixing apparatus in Embodiment 1.

FIG. 8 is a graph showing progression of a temperature of the heating roller at the time of continuous fixation by the fixing apparatus in Embodiment 1.

FIGS. 9(a) to 9(d) are schematic structural views showing other embodiments of the exciting core material of the fixing apparatus in Embodiment 1.

FIGS. 10(a) and 10(b) are schematic views each showing arrangement of an exciting core material of a fixation apparatus in Embodiment 2.

FIGS. 11(a) and 11(b) are schematic views each showing a shape of an exciting coil of a fixing apparatus in EMbodiment 4.

FIG. 12 is a graph showing a temperature distribution in a longitudinal direction of the fixing apparatus in Embodiment 4.

FIGS. 13(a) and 13(b) are schematic structural views showing another embodiment of the exciting coil of the fixing apparatus in Embodiment 4.

FIGS. 14 and 15 are schematic structural views each showing an embodiment of a fixation apparatus in Embodiment 5.

FIG. 16 is a schematic structural view of a fixing apparatus in Embodiment 6.

FIG. 17 is a graph showing a temperature-dependent permeability curve in Embodiment 1.

FIG. 18 is a graph showing a temperature-dependent resistance curve of a heating roller in Embodiment 1.

### DETAILED DESCRIPTION OF THE PREFERRED EMBODIMENT

Hereinbelow, embodiments of the present invention will be described with reference to the drawings.

### First Embodiment

(1) Embodiment of Image Forming Apparatus

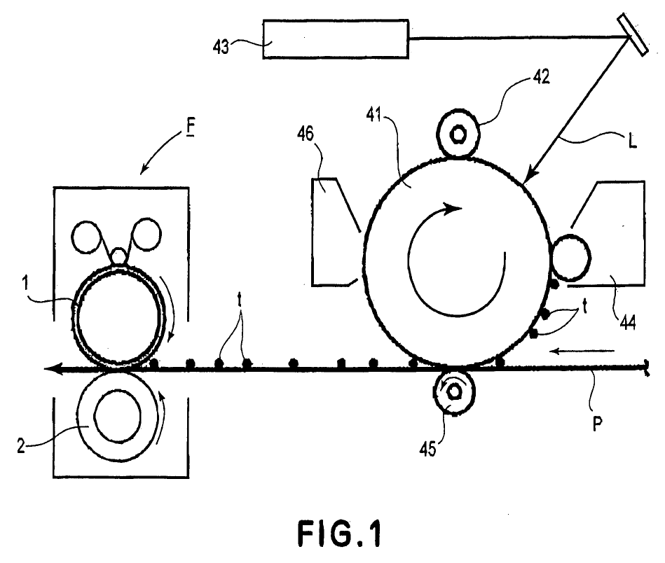

FIG. 1 is a schematic structural view of an embodiment of an image forming apparatus provided, as an image heat-fixing apparatus, with a heating apparatus of an electromagnetic induction heating type according to the present invention.

In this embodiment, an image forming apparatus is a laser scanning exposure-type digital image forming apparatus (a copying machine, a printer, a facsimile machine, a multi-functional machine of these machines, etc.) utilizing a transfer-type electrophotographic process.

A rotary drum-type photosensitive member (photosensitive drum) 41 as an image bearing member is rotationally driven in a direction of an indicated arrow at a predetermined peripheral speed. During the rotation, the photosensitive drum 41 is uniformly charged electrically to a predetermined negative dark-part potential Vd by a primary charging apparatus 42.

A laser beam scanner 43 outputs laser beam L which is modulated corresponding to a digital image signal inputted from an unshown host apparatus such as an image reader, a word processor, a computer, etc., whereby the uniformly charged surface of the photosensitive drum 41 is subjected to scanning exposure. By this laser beam scanning exposure, an exposure portion of the photosensitive drum 41 has a small potential in terms of an absolute value, as a light-part potential Vl. As a result, on the surface of the photosensitive drum 41, an electrostatic latent image corresponding to the image signal is formed. The electrostatic latent image is visualized as a toner image by depositing the negatively charged toner on the exposure portion, having the light-part potential Vl, of the photosensitive drum surface.

On the other hand, a recording sheet P fed from an unshown sheet feeding tray is conveyed to a pressure-contact portion (transfer portion) between a transfer roller 45, as a transfer member supplied with a transfer bias voltage, and the photosensitive drum 41, at appropriate timing in synchronism with the rotation of the photosensitive drum. Then, onto the surface of the recording sheet P, a toner image t on the photosensitive drum 41 is successively transferred.

The recording sheet P onto which the toner t image has been transferred from the photosensitive drum 41 is separated from the photosensitive drum 41 and conveyed to a fixing apparatus F, described later, by which the toner image t is fixed on the recording sheet P, which is then discharged outside the image forming apparatus.

On the other hand, the surface of the photosensitive drum 41 after the separation of the recording sheet P is cleaned by a cleaning apparatus 46 so as to remove a transfer residual matter, such as toner remaining on the surface of the photosensitive drum 41. The photosensitive drum 41 is then repetitively subjected to image formation.

(2) Fixing Apparatus F

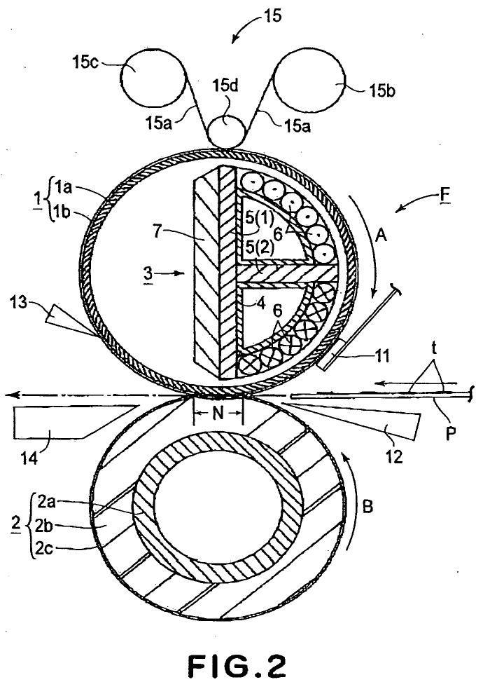

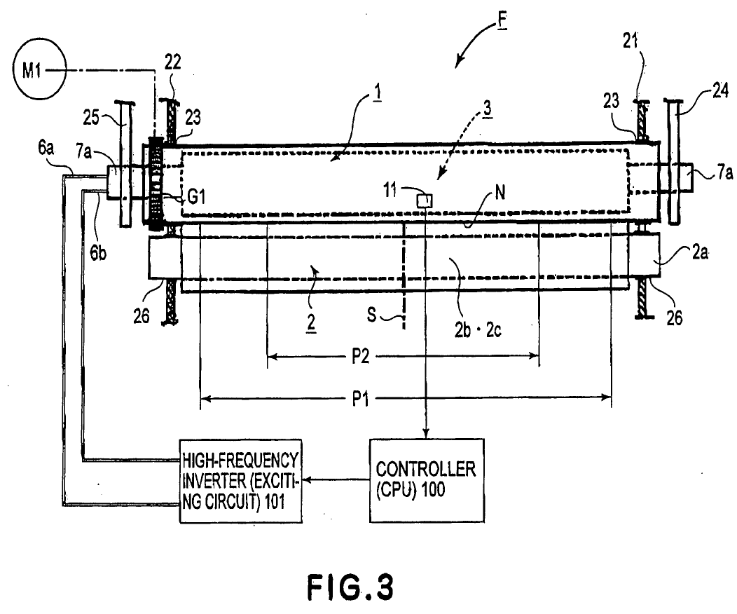

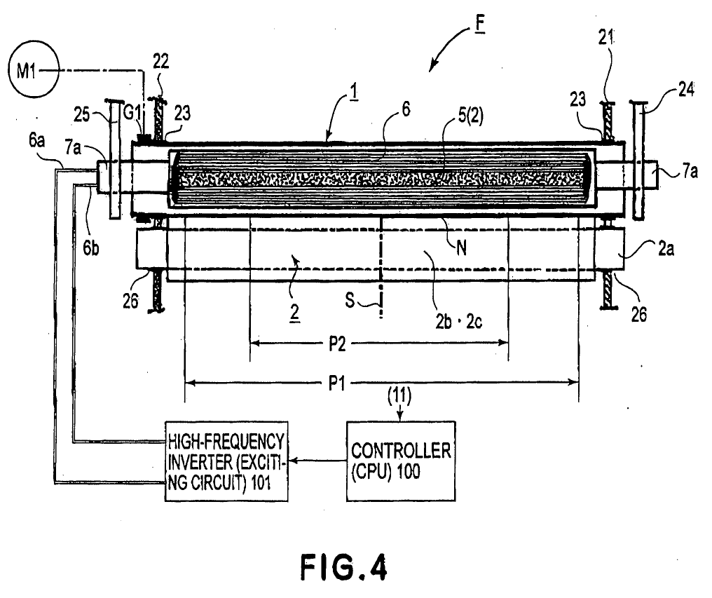

FIG. 2 is an enlarged cross-sectional view of a principal portion of the fixing apparatus F, FIG. 3 is a front view of the principal portion, and FIG. 4 is a longitudinal-sectional front view of the principal portion.

This fixing apparatus F is of a heating roller type and is a heating apparatus of an electromagnetic induction heating type according to the present invention. The fixing apparatus F principally includes a pair of heating (fixing) roller 1 (as an electroconductive (heating) member) and a pressure roller 2 (as a pressure member) which are vertically disposed in parallel and pressed against each other at a predetermined pressing force to create a fixation nip portion N having a predetermined nip width (nip length).

The heating roller 1 as the heating member has an outer diameter of 40 mm, a thickness of 5 mm, and a length of 340 mm and includes a core metal 1a (hereinafter referred to which is formed of a magnetism-adjusted alloy, comprising iron, nickel, chromium, manganese, etc., adjusted to have a Curie temperature of 210° C. (in this embodiment). At an outer peripheral surface of the roller, a 30 μm-thick surface layer 1b formed of a fluorine-containing resin, such as PFA or PTFE in order to enhance toner releasability at the surface of the heating roller. Further, in order to obtain a high-quality fixation image, such as a color image, it is also possible to dispose a heat-resistant elastic layer of silicone rubber between the core metal 1a and the surface layer 1b.

The heating roller 1 is rotatably supported between side plates (fixing unit frames) 21 and 22 (located on the front and rear sides of the fixing apparatus) each via a bearing 23 at both end portions thereof. Further, at an inner hollow portion of the heating roller 1, a coil assembly 3, as a magnetic field generation means, which generates a high-frequency magnetic field by inducing an inducted current (eddy current) in the heating roller 1 to cause Joule heat, is injected and disposed.

The pressure roller 2 has an outer diameter of 38 mm and a length 330 mm and includes a core metal 2a having an outer diameter of 28 mm and a thickness of 3 mm, a 5 mm-thick heat-resistant elastic layer 2b formed at a peripheral surface of the core metal 2a, and a 30 μm-thick surface layer 2c formed, of a fluorine-containing resin, such as PFA or PTFE, on a peripheral surface of the heat-resistant elastic layer 2b. The pressure roller 2 is disposed under and in parallel with the heating roller 1 and is rotatably held between the side plates 21 and 22 (located on the front and near sides of the fixing apparatus) each via a bearing 26 at both end portions of the core metal 2a. The heating roller 1 and pressure roller 2 are pressed against each other by an unshown pressure mechanism while resisting an elasticity of the elastic layer 2b, thus forming the fixation nip portion N having a width of about 5 mm for heat-fixing the toner image on the recording sheet P as the material to be heated by conveying the recording sheet P therebetween.

Herein, the “longitudinal (lengthwise) direction” with respect to apparatus constituting members means a direction perpendicular to the conveyance direction of the recording sheet P in a plane including the fixation nip portion N. Further, the center portion and the (both) end portions means those in the longitudinal direction, respectively.

The coil assembly 3, as the magnetic flux generation means, inserted into the inner hollow portion of the heating roller 1 is an assembly of a bobbin 4, a core material (magnetic core) 5 (1, 2) comprising a magnetic material, an exciting coil (induction coil) 6, and a stay 7 formed with an insulating member. The magnetic core material 5 is held by the bobbin 4, and the exciting coil 6 is formed by winding an electric wire around the periphery of the bobbin 4. A unit of the bobbin 4, the magnetic core material 5, and the exciting coil 6 is fixedly supported by the stay 7.

The above described coil assembly 3 is inserted into the inner hollow portion of the heating roller 1 to be placed in a position with a predetermined angle and in such a state it holds a certain gap between the heating roller 1 and the exciting coil 6, so that the stay 7 is fixedly supported in a non-rotation manner by holding members 24 and 25 at both end portions 7a and 7a thereof which are located on the front and rear sides of the fixing apparatus. The unit of the bobbin 4, the magnetic core material 5, and the exciting coil 6 is accommodated in the heating roller 1 so as not to be protruded from the heating roller 1.

The magnetic core material 5 is a material which has a high permeability and small low residual magnetic flux density and is formed of ferrite, permalloy, etc. The magnetic core material 5 has a function of guiding magnetic flux generated by the exciting coil 6 to the heating roller 1. In this embodiment, the magnetic core material 5 has a T-character shaped cross section comprising a combination of two plate-like magnetic core materials 5(1) and 5(2) constituting horizontal and vertical bar portions, respectively.

The exciting coil 6 comprises a bundle of litz wires which are, as shown in FIG. 4, extended in the longitudinal direction of the heating roller 1 and are wound around the magnetic core material 5 plural times along the shape of the bobbin 4 in an elongated boat form while being bent at both end portions. The exciting coil 6 is provided with two lead wires (coil supply wires) 6a and 6b which are led from the rear-side of the stay 7 and are connected to a high-frequency inverter (exciting circuit) 101 for supplying a high-frequency current to the exciting coil 6.

The heating roller 1 has a thermistor 11 as a temperature detection means, which is described later.

A front guide plate 12 disposed before the fixation nip portion N guides the recording sheet P conveyed from the image forming mechanism to the fixing apparatus F to an entrance of the fixation nip portion N.

A separation claw 13 functions as a mean for separating the recording sheet P from the heating roller 1 by suppressing winding of the recording sheet P, which is introduced into and passed through the fixing nip portion N, around the heating roller 1. A near guide plate 14 disposed after the fixation nip portion N guides the recording sheet P come out of an outlet portion of the fixation nip portion N to the outside of the image forming apparatus.

The above described bobbin 4, the stay 7, and the separation claw 13 are formed of heat-resistant and electrically insulating engineering plastics.

A heating roller drive gear G1 is fixed at the rear-side end portion of the heating roller 1, and a rotational force is transmitted from a drive source M1 through a transmission system, whereby the heating roller 1 is rotationally driven in a clockwise direction indicated by an arrow A at a peripheral speed of 300 mm/sec in this embodiment. The pressure roller 2 is rotated in a counterclockwise direction indicated by an arrow B by the rotational drive of the heating roller 1 by the action of a frictional force with the heating roller 1 at the fixation nip portion N.

A fixation roller cleaner 15 includes a cleaning web 15a as a cleaning member, a web feeding axis portion 15b which holds the cleaning web 15a in a roll shape, a web take-up axis portion 15c, and a pressing roller 15d for pressing the web portion between the both axis portions 15b and 15c against the outer surface of the heating roller 1. By the web portion pressed against the heating roller 1 by use of the pressing roller 15d, offset toner on the heating roller 1 surface is wiped out to clean the heating roller 1 surface. The web portion pressed against the heating roller 1 is gradually renewed by feeding the web 15a little by little from the feeding portion 15b to the take-up portion 15c.

In this embodiment, sheet passing (feeding) is performed on the basis of a centering S. In other words, all the recording sheets of any sizes pass through the heating roller in such a state that the center portion of the recording sheets passes along the center portion in the roller axis direction of the heating roller In the image forming apparatus of this embodiment, a maximum size of the recording sheet which can be passed through the fixation roller (such a recording sheet is referred to as a “large-sized sheet (paper)”) is, e.g., A4 (landscape), and a minimum size of the recording material which can be passed through the heating roller (such a recording material is referred to as a “small-sized sheet (paper)”) is, e.g., B5R. P1 represents a sheet passing area width of the large-sized sheet, and R2 represents a sheet passing area width of the small-sized sheet.

The above described thermistor 11 is disposed, as a center portion temperature detection apparatus, opposite to the exciting coil 6 via the heating roller 1 at the heating roller center portion corresponding to approximately the center portion of the sheet passing area width P2 of the small-sized sheet while being elastically pressed against the surface of the heating roller 1 by an elastic member.

Temperature detection signals of the heating roller temperature by the thermistor 11 are inputted into a control circuit portion (CPU) 100.

The control circuit portion 100 of the image forming apparatus starts a predetermined image forming sequence control by actuating the apparatus through power-on of a main switch of the apparatus. The fixing apparatus F is driven by actuating the drive source M1 to start rotation of the heating roller 1. By the rotation of the heating roller 1, the pressure roller 2 is also rotated. Further, the control circuit portion 100 actuates a high frequency inverter 101 to pass a high-frequency current (e.g., 10 kHz to 100 kHz) through the exciting coil 6. As a result, high-frequency alternating magnetic flux is generated around the exciting coil 6, whereby the heating roller 1 is heated, through electromagnetic induction, toward a predetermined fixation temperature (190° C. in this embodiment) as an image heating temperature. This temperature rise of the fixation roller 1 is detected by the thermistor 11, and detected temperature information is inputted into the control circuit portion 100.

The control circuit portion 100 controls the frequency (power) supplied from high frequency inverter 101 to the exciting coil 6 so that the detected temperature, of the fixation roller 1, which is inputted from the first thermistor 11 is kept at the predetermined fixation temperature of 190° C., thus performing temperature rise of the heating roller 1 and temperature control (heat regulation) at the fixation temperature of 190° C. The heating roller 1 is heated to the fixation temperature of 190° C. in the entire large-sized sheet passing area width P1, thus being temperature-controlled.

Herein, the “heat-resistant temperature” of the heating apparatus means a temperature at which parts of the heating apparatus are increased in temperature to be broken or exceed their heat-resistant limit when the power supplied to the heating apparatus is increased to cause the heating roller to temperature rise. In this embodiment, the heat-resistant temperature of the coating resin of the coil of the heating apparatus is 235° C., so that the heat-resistant temperature of the heating apparatus is 235° C.

Then, in the temperature-controlled state, the recording sheet P, as a material to be heated, carrying thereon an unfixed toner image t is introduced from the image formation side into the fixing nip portion N. The recording sheet P is sandwiched and conveyed between the heating roller 1 and the pressure roller 2 in the nip portion N, whereby the unfixed toner image t is heat-fixed on the surface of the recording sheet P under heat by the heating roller 1 and pressing force at the nip portion N.

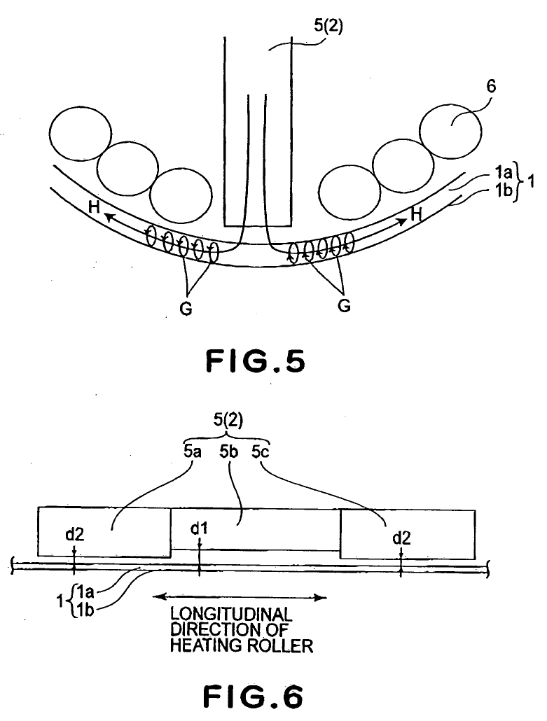

A principle of electromagnetic induction heating of the heating roller more metal 1a as an electroconductive member will be described with reference to FIG. 5.

Referring to FIG. 5 to the exciting coil 6, an AC current is applied from the high-frequency inverter 101, so that around the exciting coil 6, magnetic flux indicated by allows H is repetitively generated and removed. The magnetic flux H is guided along a magnetic patch formed by magnetic core materials 5(1) and 5(2) and a core metal 1a. With respect to the change in magnetic flux generated by the exciting coil 6, an eddy current indicated by arrows C is produced in the more metal 1a so as to penetrate magnetic flux in a direction of preventing the change in magnetic flux.

The eddy current concentratedly flows the surface of the exciting coil 6 of the core metal 1a by skin effect, whereby heat is generated at a power in proportion to a skin resistance Rs of the core metal 1a.

A skin depth δ (thickness of skin or surface layer) and the skin resistance Rs are represented by the following formulas (1) and (2):

$$\begin{matrix}δ = \sqrt{\frac{2 ρ}{ω μ}} , & ( 1 ) \\ Rs = \frac{ρ}{δ} = \sqrt{\frac{ω μ ρ}{2}} , & ( 2 )\end{matrix}$$

wherein ω represents an angular frequency of the AC current applied to the exciting coil 6, μ represents a permeability of the core metal 1a, and ρ represents a specific resistance (resistivity) of the core metal 1a.

A power W generated in the core metal 1a is represented by the following formula (3):
W∝Rs∫|If|²dS (3),
wherein “If” represents an eddy current induced in the core metal 1a.

From the above formulas (1) to (3), in order to increase a heat generating rate of the core metal 1a, the eddy current If is increased or the skin resistance Rs is increased.

In order to increase the eddy current, magnetic flux generated by the exciting coil 6 is increased or the change in magnetic flux is enlarged. For example, the number of winding of the exciting coil 6 is increased or as the magnetic core material 5, a material having a higher permeability and a lower residual magnetic flux may preferably be used. Further, a gap d between the magnetic core material 5 and the core metal 1a is decreased, whereby magnetic flux induced in the core metal 1a is increased, so that the eddy current If can be increased.

On the other hand, in order to increase the skin resistance Rs, it is preferable that a frequency of the AC current applied to the exciting coil 6 is increased or a material which has a higher permeability μ and a higher specific resistance ρ is used for the core metal 1a.

Generally, ferromagnetic material loses its spontaneous magnetization to decrease its permeability μ when it is heated up to a Curie temperature peculiar to the material. Accordingly, when the temperature of the core metal 1a (electroconductive member) of the heating roller 1 exceeds the Curie temperature, the skin resistance Rs is decreased. Further, the magnetic flux induced in the core metal 1a is also decreased, so that the eddy current If is also decreased. As a result, a heat generating rate W of the core metal 1a is lowered.

Generally, the skin resistance Rs is determined, as shown in the formula (2), by the permeability μ and the resistivity ρ in the case of a constant frequency, and the resistivity is generally moderately increased with temperature increase.

FIG. 18 is a graph showing a temperature-dependent curve of an electrical resistance of the heating roller in this embodiment.

In the present invention, by using a magnetic-adjusted alloy having a Curie temperature adjusted to be a predetermined temperature as a material for the core metal 1a, the Curie temperature is not less than a fixation temperature and less than a heat-resistance temperature of the fixing apparatus. As a result, when the temperature of the heating roller is close to the Curie temperature, the permeability is abruptly lowered with the increase in temperature. For this reason, as shown in FIG. 18, the electric resistance of the heating roller 1 applied to the coil at least have a temperature range, in which the electric resistance of the heating roller is decreased, being a range of a temperature lower than the heat-resistant temperature of the fixing apparatus (i.e., the heating roller resistance has a maximum at a temperature lower than the heat-resistant temperature of the fixing apparatus. As a result, the decrease in electric resistance causes a lowering in heat generating rate. For this reason, different from a conventional heating roller having an electric resistance which is increased with temperature, the heat generating rate is decreased with temperature rise. As a result, it is possible to alleviate the temperature rise at the non-sheet passing portion. Further, with the decrease in permeability, an amount of the eddy current is also decreased, so that the heat generating rate is rapidly lowered.

Further, in order to shorten a start-up time (warm-up time) required for increasing the heating roller temperature up to the fixation temperature, the temperature for the above described maximum resistance is increased as higher as possible so as to be not less than the fixation temperature. By doing so, the resistance is not decreased until the heating roller temperature reaches the fixation temperature. As a result, it is possible to perform the heating of the heating roller efficiently.

Further, in such a temperature range that the temperature of the heating roller is not less than a predetermined fixation temperature and less than the heat-resistant temperature of the fixing apparatus, the material for the heating roller is prepared so that it has a temperature range such that the roller resistance is lower than that at least at the fixation temperature. By doing so, it is possible to decrease the heat generating rate at the non-sheet passing portion compared with the heat passing portion. As a result, the temperature rise at the non-sheet passing portion can be alleviated.

Herein, the (skin) resistance Rs of the heating roller 1 corresponds to an apparent load resistance of the heating roller applied to the coil when the magnetic flux is mounted in the heating roller and a current is passed through the coil.

The apparent (load) resistance and its temperature dependence are determined in the following manner.

By using an LCR meter (Model “HP4194A”, mfd. by Agilent Technologies Inc.), an electric resistance of the heating roller is measured when an AC with a frequency of 20 kHz is applied. In this case, the measurement is performed in such a state that the heating roller 1, the exciting coil (magnetic flux generation means), and the core (magnetic flux generation means) are mounted in the heating apparatus. While changing the temperature of the heating roller, the temperature and the resistance value are plotted at the same time, whereby a temperature characteristic curve of the resistance of the heating roller 1 can be obtained.

The temperature of the heating roller 1 is changed in such a state that the heating roller 1 and the magnetic flux generation means are placed in a thermostatic chamber while being mounted in the heating apparatus so as to keep their positional relationship, so that the heating roller temperature is saturated as a temperature in the thermostatic chamber and then the resistivity is measured in the above described manner.

As described above, as the material for the core metal 1a, the magnetism-adjusted alloy having a Curie temperature adjusted to be a predetermined temperature, specifically such a temperature that is higher than a fixation temperature as a heating temperature for the material to be heated and in an acceptable temperature rise range for the non-sheet passing portion temperature rise, is used, whereby a heat generating rate of the core metal 1a is abruptly lowered at a temperature close to the Curie temperature. For this reason, even in the case of passing the small-sized sheet, it is possible to prevent or alleviate an occurrence of temperature rise at the non-sheet passing portion.

As described above, the heat generating rate of the heating roller 1 is gradually decreased with an increasing temperature of the core metal 1a, as the electroconductive member of the heating roller 1, up to the Curie temperature. For this reason, whey the Curie temperature is substantially equal to the fixation temperature, a quick start performance is impaired. Accordingly, it is desirable that the fixation temperature is set to be lower than the Curie temperature.

In this embodiment, as described above, the Curie temperature of the core metal 1a as the electroconductive member of the heating roller 1 is set to 210° C., and the fixation temperature is set to 190° C.

Herein, the fixation temperature means a temperature of the heating roller at the time of fixing the toner on the recording material (sheet). In this embodiment, the fixation temperature (190° C.) may be appropriately changed. For example, the present invention is applicable even when a plurality of fixation temperatures are set depending on the thickness of the recording material to be conveyed or a thermal storage state of the heating roller. In this case, when the above described relationship is satisfied with respect to at least one of the plurality of fixation temperatures, the effect of the present invention can be achieved.

In the present invention, the permeability is measured in the following manner by use of B-H analyzer (Model “SY-8232”, mfd. by Iwatsu Test Instruments Co.).

Around a measuring sample, predetermined primary and secondary coils of a measuring apparatus are wound and subjected to measurement at a frequency of 20 kHz. With respect to the measuring sample, it is possible to any material so long as it has such a shape that the coils can be wound around it since a ration between temperatures at which permeabilities are different from each other is little changed.

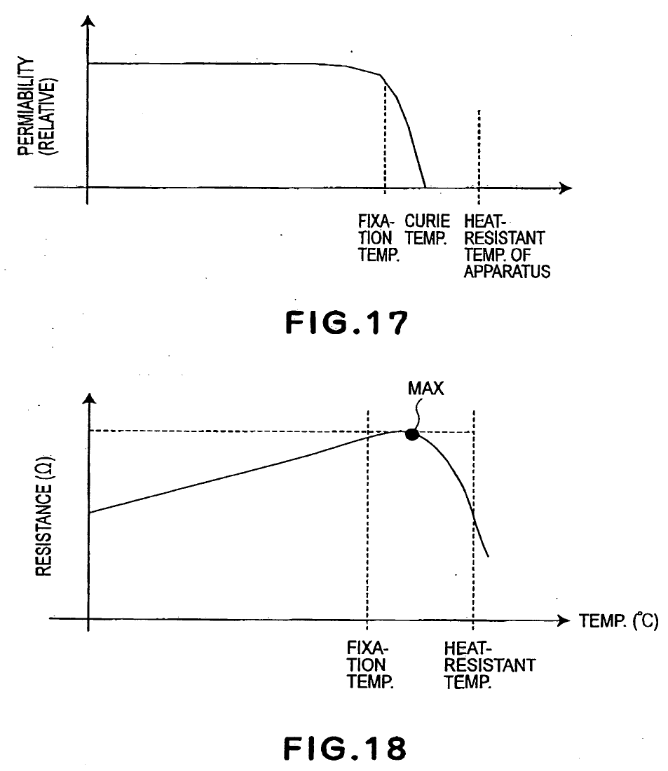

After completion of the winding of the coils around the measuring sample, the sample is placed in a thermostatic chamber to saturate the temperature. Then, permeability at the saturation temperature is plotted. By changing the temperature in the thermostatic chamber, it is possible to obtain a temperature-dependent curve of the permeability. The temperature at which the permeability is 1 is used as a Curie temperature (FIG. 17), and is determined in the following manner. When the temperature in the thermostatic chamber is increased, the permeability does not change at a certain temperature. This temperature is regarded as a Curie temperature, i.e., a temperature at which the permeability becomes 1. The thus measured temperature-dependent permeability is shown by a curve indicated in FIG. 17.

This embodiment is characterized in that a heat generating rate at an end portion or its neighborhood of the heating roller in its longitudinal direction is larger than that at a center portion or its neighborhood by setting a distance between the magnetic core material 5 and the core metal 1a (electroconductive member) of the heating roller 1 so that the gap at the end portion or its neighborhood is smaller than that at the end portion or its neighborhood.

More specifically, FIG. 6 is a view showing an arrangement of the magnetic core material 5(2) in the fixing apparatus F in this embodiment in the longitudinal direction of the heating roller. In an actual state, the exciting coil 6 is wound around the magnetic core material 5(2) but is omitted from FIG. 6.

In this embodiment, the magnetic core material 5(2) is divided into three portions (divided core materials) 5a, 5b and 5c in the longitudinal direction of the heating roller. A distance d1 between the core material 5b and the core metal 1a at the center portion is 5 mm, and a distance d2 between the core materials 5a and 5c and the core metal 1a at the both end portions is 2.5 mm.

As a result, magnetic flux induced in the core metal 1a at the both end portions can be larger than that at the center portion, so that the resultant heat generating rate at the both end portions becomes larger than that at the center portion. For this reason, it is possible to solve the problem of end portion temperature lowering of the heating roller 1.

The magnetic flux generated from the coil and core as the magnetic flux generation means may be measured in the following manner.

A distribution of generated magnetic flux (a relationship in magnitude between magnetic fluxes at the end portions and the center portion) can be measured by use of a flux meter which is a commercially available apparatus for detecting an amount of generated magnetic flux. More specifically, an AC with a frequency of 20 kHz is passed through the magnetic flux generation means. In this state, by measuring the amount of magnetic flux corresponding to that generated at the end portion or its neighborhood and the amount of magnetic flux corresponding to that generated at the center portion or its neighborhood while maintaining a predetermined distance, between a magnetic flux detection portion of the flux meter and a measuring point, which is not more than an actual distance between the magnetic flux generation means and the heating roller. As a result, it is possible to determine the magnetic flux magnitude relationship between at the end portions and the center portion.

In the present invention, the measurement is performed by setting the distance from the magnetic flux generation means so as to be equal to the distance between the heating roller and the magnetic flux generation means.

As Comparative Embodiments 1 and 2, a distance between the magnetic core material 5(2) and the core metal 1a is charged to 5 mm (Comparative Embodiment 1) and 2.5 mm (Comparative Embodiment 2) uniformly over the center portion and end portions in the longitudinal direction of the heating roller. As a material for the core metal 1a, iron having a Curie temperature of 769° C. (Comparative Embodiment 1) and nickel having a Curie temperature of 358° C. (Comparative Embodiment 2) are used.

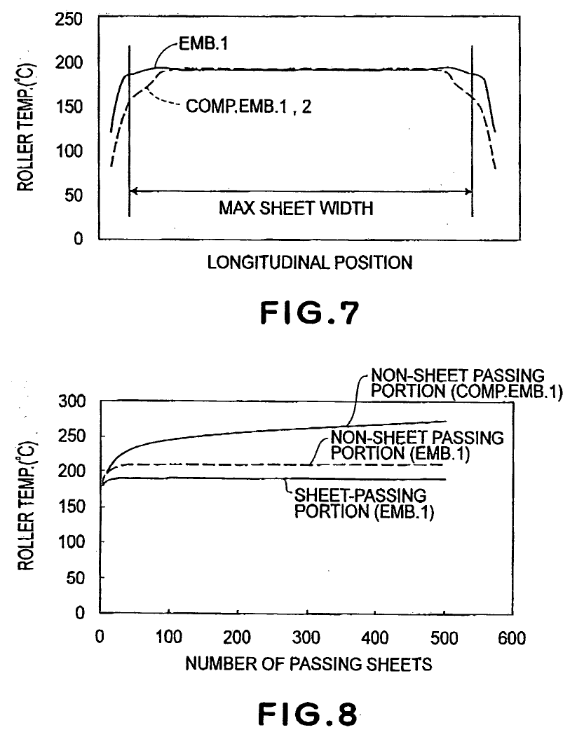

FIG. 7 shows heating roller surface temperature distributions in the longitudinal direction of the heating roller in a fixable state (standby state) with respect to Embodiment 1 (FIG. 6) and Comparative Embodiments 1 and 2.

In this embodiment (FIG. 6), a difference in surface temperature between at the center portion and the end portions in the heating roller longitudinal direction was about 10° C. In both of Comparative Embodiments 1 and 2, the temperature difference was 40° C. or above. In these states, when the recording sheet was subjected to fixation, in this embodiment, a good fixation image was obtained but in both of Comparative Embodiments 1 and 2, fixation failure was caused to occur at the both end portions.

FIG. 8 shows surface temperature progressions of the heating rollers of this embodiment (Embodiment 1) and Comparative Embodiment 1 in the case where 500 small-sized sheets are continuously subjected to fixation.

In this embodiment, temperature rise of the heating roller surface temperature in the non-sheet passing portion, i.e., an area through which the sheets were not passed was stopped at 210° C. (the Curie temperature of the core metal 1a), so that it was possible to improve (alleviate) the temperature rise at the non-sheet passing portion. On the other hand, in Comparative Embodiment 1, the heating roller surface temperature was increased up to 270° C. and offset was caused to occur.

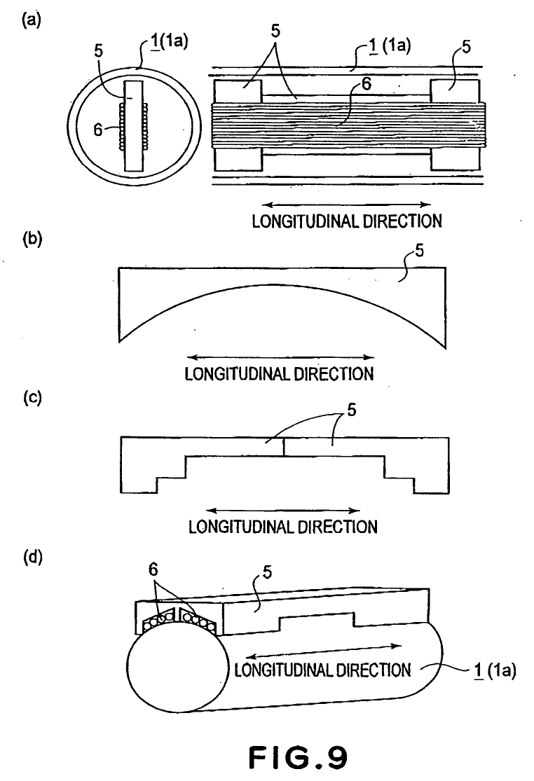

With respect to the arrangement of the exciting coil 6 and the magnetic core material 5 in this embodiment (Embodiment 1), it is possible to employ other arrangements thereof, e.g., as shown in FIGS. 9(a) to 9(d).

More specifically, as shown in FIG. 9(a), even when the magnetic core material 5 has an I-character shape, it is possible to remedy the problem of end portion temperature lowering by appropriately changing a distance between the magnetic core material 5 and the core metal 1a with respect to the center portion and the end portions in the heating roller longitudinal direction.

Further, as shown in FIGS. 9(b) and 9(c), with respect to the center portion and the end portions, the distance between the magnetic core material 5 and the core metal 1a may appropriately changed continuously or stepwise.

Further, as shown in FIG. 9(d), it is also possible to employ such an external heating scheme that the exciting coil 6 and the magnetic core material 5 (which are the magnetic flux generation means) are disposed outside the heating roller 1 and the surface of the heating roller 1 is directly heated. That is, the distance between the core metal 1a and the magnetic core material 5 at the both end portions is smaller than that at the center portion in the heating roller longitudinal direction, so that it is possible to expect the above described effect of Embodiment 1.

Further, in this embodiment, the heating apparatus is of the heating roller type but may also be of a belt-type using an endless belt.

### Embodiment 2

In this embodiment, the magnetic core material is divided into plural portions and disposed so that each of divided portions of the magnetic core material at the center portion has a size smaller than that at the end portions, whereby a heat generating rate at the end portions in the heating roller longitudinal direction is larger than that at the center portion.

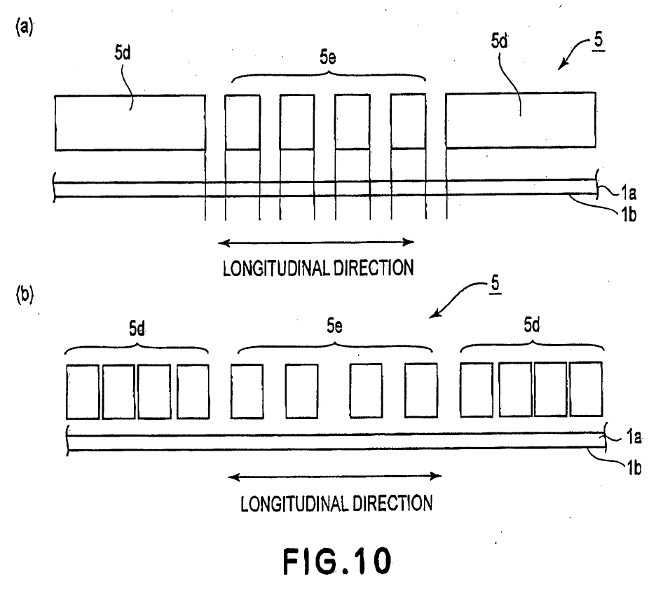

More specifically, in FIG. 10(a), a magnetic core material 5 is divided into two magnetic core material portions 5d and 5d each having a width of 80 μm and magnetic core material portions 5e each having a width of 20 μm with a spacing S of 12 μm between adjacent portions. In other words, the spacings S, where the magnetic core material 5 is not disposed opposite to the core metal 1a, are located at the center portion in the heating roller longitudinal direction. As a result, magnetic flux induced in the core metal 1a at the both end portions is lager than that at the center portion. As a result, a heat generating rate at the both end portions becomes larger than that a the center portion in the longitudinal direction of the heating roller 1, so that it is possible to solve the problem of the end portion temperature lowering of the heating roller 1.

In this embodiment, in the standby state, a surface temperature difference between at the center portion and at the both end portions was about 5° C. When the recording sheet was subjected to fixation in this state, it was possible to obtain a good fixation image.

Further, in this embodiment, even when 500 small-sized sheets were continuously subjected to fixation, temperature rise of the heating roller surface temperature at the non-sheet passing portion was stopped at 210° C. (the Curie temperature of the core metal 1a), so that it was possible to alleviate the (excessive) non-sheet passing portion temperature rise.

The arrangement of the exciting coil 6 and the magnetic core material 5 may be changed to that shown in FIG. 10 (b). Compared with the case of FIG. 10(a) as shown in FIG. 10(b), the magnetic core material portions 5d at the both end portions are further divided into smaller magnetic core material portions with a spacing therebetween which is smaller than that at the center portion. In other words, in this embodiment, the magnetic core material portions so that each spacing (where the magnetic core material 5 is not disposed opposite to the core metal 1a) at the center portion is larger than that at the both end portions, whereby magnetic flux induced in the core metal 1a at the both end portions becomes larger than that at the center portion. As a result, a heat generating rate at the both end portions is larger than that at the center portion in the heating roller longitudinal direction, so that it is possible to solve the problem of heating roller end portion temperature lowering.

Further, further improved effects can be expected by employing the above described Embodiments 1 and 2 in combination.

### Embodiment 3

In this embodiment, the magnetic core material is divided into plural portions and disposed so that a relative permeability of divided portions of the magnetic core material at the end portions is larger than that at the center portion, whereby a heat generating rate at the end portions in the heating roller longitudinal direction is larger than that at the center portion.

More specifically, in the fixing apparatus F used in Embodiment 1 (FIG. 6), a magnetic core material 5 is divided into two magnetic core material portions 5a and 5c each formed of a ferrite core having a relative permeability of 3000 and one magnetic core material portion 5b formed of a ferrite core having a relative permeability of 1000.

As a result, magnetic flux induced in the core metal 1a at the both end portions is lager than that at the center portion. As a result, a heat generating rate at the both end portions becomes larger than that a the center portion in the longitudinal direction of the heating roller 1, so that it is possible to solve the problem of the end portion temperature lowering of the heating roller 1.

In the fixing apparatus of this embodiment, in the standby state, a surface temperature difference between at the center portion and at the both end portions was about 3° C. When the recording sheet was subjected to fixation in this state, it was possible to obtain a good fixation image.

Further, in this embodiment, even when 500 small-sized sheets were continuously subjected to fixation, temperature rise of the heating roller surface temperature at the non-sheet passing portion was stopped at 210° C. (the Curie temperature of the core metal 1a), so that it was possible to alleviate the (excessive) non-sheet passing portion temperature rise.

With respect to the relative permeability, similar effects can be expected even when other structures are employed so long as the relative permeability at the both end portions is larger than that at the center portion in the longitudinal direction of the heating roller.

Further, further improved effects can be expected by comprising Embodiment 3 with the above described Embodiment 1 and/or 2.

### Embodiment 4

In this embodiment, an exciting coil comprises wound conductor wires which are extended in the longitudinal direction of the heating roller and bent at both end portions thereof. The bending portions are subjected to pressing treatment or placed in a turn-back state, whereby a heat generating rate at the both end portions in the heating roller longitudinal direction is larger than that at the center portion.

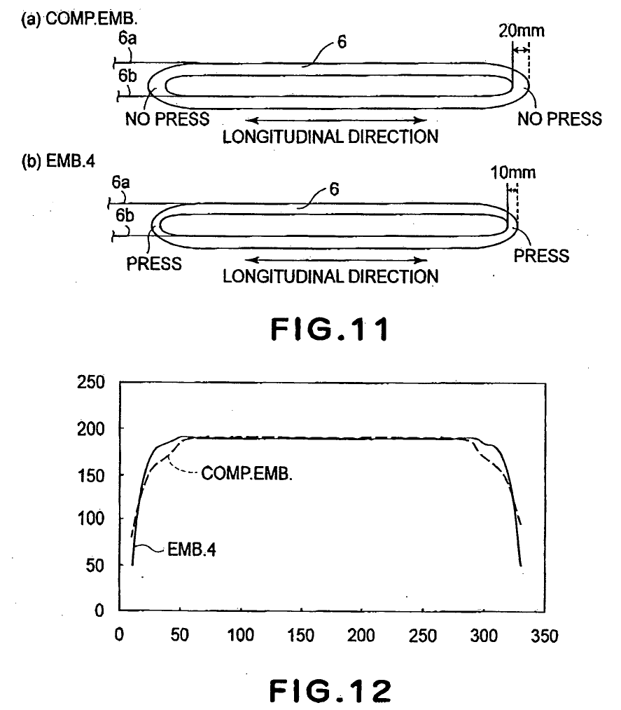

More specifically, FIGS. 11(a) and 11(b) are schematic views showing a shape of an exciting coil 6 in Comparative Embodiment and that in this embodiment (Embodiment 4), respectively. In these figures, each of the exciting coils 6 comprises Litz were consisting of a bundle of 120 conductor wires (surfaces of which are subjected to heat-resistant insulating treatment) and wound six times in the heating roller longitudinal direction. In Comparative Embodiment shown in FIG. 11(a), the bending portions at the both end portions of the exciting coil 6 are not subjected to pressing treatment, so that each of the bending portions has a difference between inner and outer diameters of 20 mm. On the other hand, in this embodiment shown in FIG. 11(b), the bending portions at the both end portions of the exciting coil 6 are subjected to pressing treatment in the heating roller longitudinal direction, so that each of the bending portions has a difference between inner and outer diameters of 10 mm. By subjecting the bending portions at the both end portions of the exciting coil 6 to the pressing treatment, a density of magnetic flux induced in the heating roller 1 at its end portions located opposite to those of the exciting coil 6 becomes larger. As a result, a heat generating rate at the end portions of the heating roller 1 is larger than that at the center portion of the heating roller 1, so that it is possible to solve the problem of end portion temperature rise of the heating roller 1.

In this embodiment, other than the shape of the exciting coil 6, the fixing apparatus has the same constitution as that in Embodiment 1 shown in FIGS. 2, 3 and 4.

FIG. 12 shows surface temperature distributions of the heating rollers using the exciting coil 6 shown in FIG. 11(b) (in this embodiment) and that shown in FIG. 11(a) (in Comparative Embodiment), respectively, in their standby state. In this embodiment, a difference in surface temperature between at the center portion and the both end portions was about 12° C. On the other hand, in Comparative Embodiment, the temperature difference was 30° C. or above. In these states, when the recording sheet was subjected to fixation, a good fixation image was obtained in this embodiment but in Comparative Embodiment, fixation failure was caused to occur at the both end portions of the heating roller.

Further, in this embodiment, even when 550 small-sized recording sheets were continuously subjected to fixation, temperature rise of the surface temperature at the non-sheet passing portion of the heating roller was stopped at 210° C. (the Curie temperature of the core metal 1a of the heating roller 1), so that it was possible to alleviate the non-sheet passing portion temperature rise.

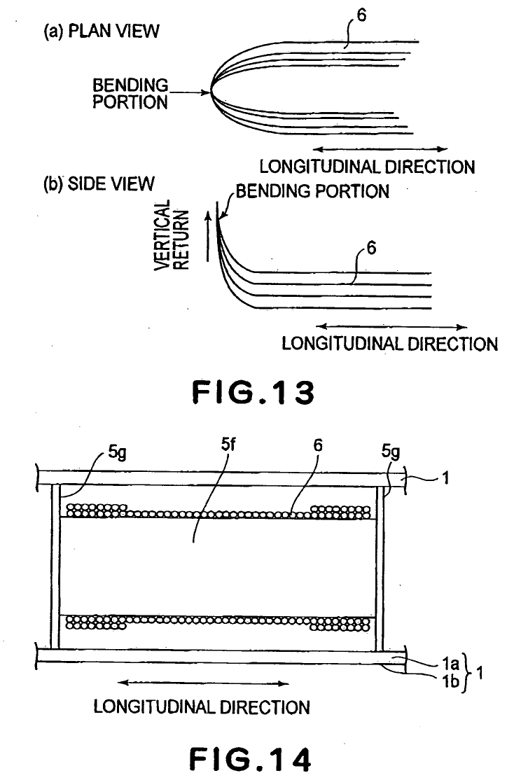

With respect to the shape of the exciting coil 6, similar effects can be expected even when the shape of the exciting coil 6 is changed as shown in FIGS. 13(a) and 13(b), wherein the bending portions at the both end portions of the exciting coil 6 are those which are turned back in a direction substantially perpendicular to the longitudinal direction of the exciting coil 6.

Further, by combining this embodiment (Embodiment 4) with at least one of Embodiments 1 to 3 described above, further proposed effects can be expected.

### Embodiment 5

In this embodiment, an exciting coil comprises wound conductor wires which are wound along the circumferential surface of the heating roller (in a direction perpendicular to the longitudinal direction) so that the number of winding per unit length at both end portions of the conductor wires in the longitudinal direction of the heating roller is larger than that at the center portion of the conductor wires, whereby a heat generating rate at the both end portions of the heating roller in the heating roller longitudinal direction is larger than that at the center portion.

More specifically, FIG. 14 is a schematic view showing a shape of an exciting coil 6 in this embodiment. Inside the heating roller 1, a magnetic core material 5f, having an outer diameter of 35 mm, around which the exciting coil 6 is wound, and end portion magnetic core materials 5g, located at both end portions of the magnetic core material 5f, for forming magnetic path with the heating roller magnetic coil 1a, are disposed as shown in FIG. 14. In FIG. 14, the exciting coil 6 comprises Litz were consisting of a bundle of 120 conductor wires (surfaces of which are subjected to heat-resistant insulating treatment) and wound so that the exciting coil 6 is wound around the magnetic core material 5f two times in an end area of 80 mm from each end of the magnetic core material 5f in the longitudinal direction of the magnetic core material 5f and is wound one time in a center area of 140 mm. As a result, an amount of eddy current induced at the both end portions of the core metal 1a of the heating roller 1 disposed opposite to the magnetic core material 5f is larger than that at the center portion of the core metal 1a, so that it is possible to solve the problem of end portion temperature lowering of the heating roller 1.

As Comparative embodiment, the exciting coil 6 is wound on time around the entire magnetic core material 5f.

With respect to surface temperature distributions of the heating rollers using the exciting coil 6 in this embodiment and that in Comparative Embodiment, respectively, in their standby state. In this embodiment, a difference in surface temperature between at the center portion and the both end portions was about 5° C. in this embodiment. On the other hand, in Comparative Embodiment, the temperature difference was 20° C. or above. In these states, when the recording sheet was subjected to fixation, a good fixation image was obtained in this embodiment but in Comparative Embodiment, fixation failure was caused to occur at the both end portions of the heating roller.

Further, in this embodiment, even when 550 small-sized recording sheets were continuously subjected to fixation, temperature rise of the surface temperature at the non-sheet passing portion of the heating roller was stopped at 210° C. (the Curie temperature of the core metal 1a of the heating roller 1), so that it was possible to alleviate the non-sheet passing portion temperature rise.

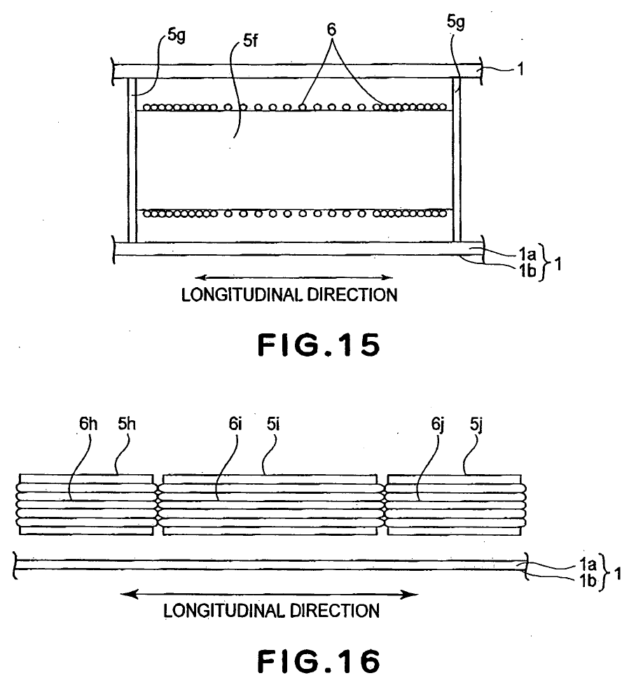

With respect to the winding manner of the is exciting coil 6, similar effects can be expected, e.g., as shown in FIG. 15, when the exciting coil 6 is wound around the magnetic core material 5f so that a density of the wound exciting coil 6 at its both longitudinal end portions is larger than that at its longitudinal center portion.

Further, by combining this embodiment (Embodiment 5) with at least one of Embodiments 1 to 3 described above, further proposed effects can be expected.

### Embodiment 6

In this embodiment, an exciting coil is divided into first to third coils in the longitudinal direction of the heating roller and magnetic fluxes of second and third exciting coils located at both end portions of the exciting coil are lager than that of a first exciting coil located at a center portion of the exciting coil, whereby a heat generating rate at the both end portions in the heating roller longitudinal direction is larger than that at the center portion.

More specifically, FIG. 16 is a schematic view showing a shape of the exciting coil in this embodiment. Referring to FIG. 16, a magnetic core material is divided into three magnetic core materials 5h, 5i and 5j; around which corresponding three (divided) exciting coils 6h, 6i and 6j; respectively, are wound in series. The exciting coils 6h and 6j located at the both end portions are wound six times around the magnetic core materials 5h and 5j; respectively, and the exciting coil 6i located at the center portion is wound four times around the magnetic core material 5i.

By doing so, magnetic flux generated by the end exciting coils 6h and 6j is larger than that generated by the center exciting coil 6i. As a result, a heat generating rate at the end portions of the heating roller 1 is larger than that at the center portion of the heating roller 1, so that it is possible to solve the problem of end portion temperature rise of the heating roller 1.

In this embodiment, a difference in surface temperature between at the center portion and the both end portions was about 8° C. In this state, when the recording sheet was subjected to fixation, a good fixation image was obtained.

Further, even when 550 small-sized recording sheets were continuously subjected to fixation, temperature rise of the surface temperature at the non-sheet passing portion of the heating roller was stopped at 210° C. (the Curie temperature of the core metal 1a of the heating roller 1), so that it was possible to alleviate the non-sheet passing portion temperature rise.

In this embodiment, the number of winding of the exciting coil 6, is different between at the center portion and at the both end portions, but similar effects can be expected, e.g., even in the case where the number of frequency of the AC current applied to the exciting coil 6i located at the center portion of the entire exciting coil is different from that at the both end portions of the entire exciting coil or in the case where a relative permeability of the exciting coil is different between at the center portion and at the both end portions, since magnetic flux generated by the end exciting coils 6h and 6j becomes larger than that generated by the center exciting coil 6i.

Further, by combining this embodiment (Embodiment 6) with at least one of Embodiments 1 to 5 described above, further proposed effects can be expected.

### Other Embodiments

1) The heating apparatus of the electromagnetic induction heating type according to the present invention is not limited to be used as the image heat-fixing apparatus as in the above described embodiment but is also effective as a provisional fixing apparatus for provisionally fixing an unfixed image on a recording sheet or an image heating apparatus such as a surface modification apparatus for modifying an image surface characteristic such as glass by reheating a recording sheet carrying thereon a fixed image. In addition, the heating apparatus of the present invention is also effective as a heating apparatus for heat-treating a sheet-like member, such as a hot press apparatus for removing rumples of bills or the like, a hot laminating apparatus, or a hot-drying apparatus for evaporating a moisture content of paper or the like.

2) The shape of the heating member is not limited to the roller shape but may be other rotational body shapes, such as an endless belt shape. The heating member may be constituted by not only a single electroconductive member as an induction heating element or a multilayer member having two or more layers including a layer of the electroconductive layer and other material layers of heat-resistant plastics, ceramics, etc.

3) The induction heating scheme of the electroconductive member by the magnetic flux generation means is not limited to the internal heating scheme but may be an external heating scheme in which the magnetic flux generation means is disposed outside the electroconductive member.

4) The temperature detection means 11 is not limited to the thermistor may be any temperature detection element of a contact type or a non-contact type.

5) The heating apparatus of the present invention has such a mechanism for conveying the material to be heated (recording sheet) on the center basis but may be effectively applied as such an apparatus having a mechanism for conveying the material on one side basis.

6) Further, the heating apparatus of the present invention has such a structure that the large- and small-sized (two kinds of) materials (sheets) to be heated (recording sheets) but is applicable to an apparatus by which three or more kinds of sizes are subjected to sheet feeding or passing.

Further, in the above described embodiments, the heat-resistant temperature of the heating apparatus is that of the coil (235° C.) but is not limited thereto.

While the invention has been described with reference to the structures disclosed herein, it is not confined to the details set forth and this application is intended to cover such modifications or changes as may come within the purposes of the improvements or the scope of the following claims.

This application claims priority from Japanese Patent Application No. 434280/2003 filed Dec. 26, 2003, which is hereby incorporated by reference.

1. A heating apparatus, comprising:
a heat generation member for generating heat by magnetic flux generated by magnetic flux generation means; said heat generation member heating an image, on a material to be heated, by the heat generated by said heat generation member,
wherein said heat generation member has a Curie temperature which is not less than an image heating temperature and is less than a heat-resistant temperature of said heating apparatus, and an amount of magnetic flux generated by the magnetic flux generation means at an end portion of said heat generation member is larger than that at a center portion of said heat generation member in a widthwise direction of said heat generation member perpendicular to a conveyance direction of the material to be heated.

2. An apparatus according to claim 1, wherein said magnetic flux generation means comprises at least a coil for generating magnetic flux and a core material for guiding the magnetic flux generated by said magnetic flux generation means to said heat generation member.

3. An apparatus according to claim 2, wherein with respect to the widthwise direction, a distance between the core material and said heat generation member at the end portion of said heat generation member is smaller than that of the center portion of said heat generation member.

4. An apparatus according to claim 2, wherein with respect to the widthwise direction, a distance between adjacent core material portions at the end portion of said heat generation member is smaller than that at the center portion of said heat generation member.

5. An apparatus according to claim 2, wherein with respect to the widthwise direction, a permeability of the core material at the end portion of said heat generation member is larger than that of the center portion of said heat generation member.

6. An apparatus according to claim 2, wherein with respect to the widthwise direction, a cross-sectional area of the core material at the end portion of said heat generation member is larger than that at the center portion of said heat generation member.

7. An apparatus according to claim 2, wherein with respect to the widthwise direction, the number of winding of said coil at the end portion of said heat generation member is larger than that of the center portion of said heat generation member.

8. An apparatus according to claim 2, wherein with respect to the widthwise direction, the number of winding per unit length of said coil at the end portion of said heat generation member is larger than that at the center portion of said heat generation member.

9. An apparatus according to claim 2, wherein with respect the widthwise direction, said coil is divided into first, second and third coils, and densities of magnetic field generated by the second and third coils located at both end portions are larger than a density of magnetic field generated by the first coil located at a center portion.

10. An apparatus according to claim 2, wherein said heating apparatus further comprises temperature detection means for detecting a temperature of said heat generation member and temperature control means for controlling the temperature of said heat generation member at a predetermined image heating temperature depending on an output from the temperature detection means.

11. A heating apparatus, comprising:
a heat generation member for generating heat by magnetic flux generated by magnetic flux generation means, said heat generation member heating an image on a material, to be heated, by the heat generated by said heat generation member,
wherein said heat generation member has at least a temperature area in which a resistance thereof is decreased with temperature rise thereof within a temperature range in which a temperature of said heat generation member is lower than a heat-resistant temperature of said heating apparatus, and an amount of magnetic flux generated by the magnetic flux generation means at an end portion of said heat generation member is larger than that at a center portion of said heat generation member in a widthwise direction of said heat generation member perpendicular to a conveyance direction of the material to be heated.

12. An apparatus according to claim 11, wherein said heat generation member has at least a temperature area in which a resistance thereof is lower than that at an image heating temperature of said heat generation member.

13. An apparatus according to claim 11, wherein said heat generation member has a resistance in the temperature area which provide a ratio, between it and a resistance at an image heating temperature thereof, of not more than 0.9.

14. An apparatus according to claim 14, wherein said heat generation member has a temperature at which the resistance becomes a maximum between an image heating temperature and the heat-resistant temperature.
